(19) United States
(12) Patent Application Publication
(10) Pub. No.: US 2006/0026446 A1
(43) Pub. Date: Feb. 2, 2006

(54) Signal processing object

(76) Inventor: Frederick H. Schlereth, Syracuse, NY (US)

Correspondence Address: BOND, SCHOENECK & KING, PLLC, 10 BROWN ROAD, SUITE 201, ITHACA, NY, 14850-1248, US

(21) Appl. No.: 11/190,594

(22) Filed: Jul. 27, 2005

Related U.S. Application Data
(60) Provisional application No. 60/591,331, filed on Jul. 27, 2004.

(51) Int. Cl. G06F 1/26; G06F 1/30

(52) U.S. Cl. 713/300

(57) ABSTRACT

The present invention is a digital signal processing object that includes at least one summer element and at least one delay register connected to the at least one summer element. The combination of the at least one summer element and the at least one delay register is arranged and configured to solve a term of a difference equation. The digital signal is processed as an independent variable in the difference equation.

### CROSS-REFERENCE TO RELATED APPLICATIONS

This Application claims priority under 35 U.S.C. §119(e) based on U.S. Provisional Patent Application Ser. No. 60/591,331 filed Jul. 27, 2004, the contents of which are relied upon and incorporated herein by reference in their entirety.

### BACKGROUND OF THE INVENTION

1. Field of the Invention

The present invention relates generally to computing, and particularly to digital signal processing.

2. Technical Background

Digital Signal Processing (DSP) is an area of computer science that processes signals that typically represent physical phenomena obtained from one or more sensors. DSP has a wide variety of applications and its importance is evident in such fields as pattern recognition, radio communications, telecommunications, radar, biomedical engineering, and as well as many others. For example, the digital signals may represent RF data, seismic vibrations, video or other visual images, sound waves, and etc. By definition, DSP processes signals by representing them as sequences of numbers or variables.

Signals received by a DSP system are first converted to a digital format by an A/D converter before being used by the DSP device. The DSP computer is programmed to execute a series of mathematical operations on the digitized signal. The purpose of these operations may be to estimate characteristic parameters of the signal, or to transform the signal into a form which is, in some sense, more desirable. Such operations typically implement complicated mathematics and entail intensive numerical processing such as matrix multiplication, matrix-inversion, Fast Fourier Transforms (FFT), auto and cross correlation, Discrete Cosine Transforms (DCT), polynomial equations, and difference equations.

While conventional DSP devices offer many features and benefits, there are drawbacks associated with such devices. For example, such devices may require an inordinate amount of power. Traditional DSP devices may have one to four multipliers, and may require memory transfers between processors. Global RAM may also be required to perform the desired signal processing operations. In a traditional DSP, the multipliers are time-shared among the required processing operations.

What is needed is a device having higher speed, lower power, smaller size, easier programming, verifiability and lower cost as compared to a traditional DSP processor.

### SUMMARY OF THE INVENTION

The present invention is directed to a novel DSP referred to herein as a Signal Processing Object (SPO). An SPO is a digital signal processing circuit that is an alternative to traditional DSP circuits currently being offered. The basic advantages of the SPO, compared to traditional DSP, are higher speed, lower power, smaller size, easier programming, verifiability and lower cost.

A size and power advantage is obtained through the use of low order number representation (bit, nibble, byte, e.g.) without sacrificing word length. Speed advantage is obtained through the use of highly parallel operation (˜100 multipliers). Further speed advantage is obtained by providing local memory at the individual processor level.

Verifiability refers to the ability to “prove” that a design meets specifications rather than qualifying a design by exhaustive testing procedures. Verifiability is important as the complexity of a design increases. A SPO-based design is verifiable because there is a direct mathematically traceable correspondence between the equations specifying the operations and the hardware implementation. Unlike traditional DSP-based designs, there is no intermediary programming step. This feature also results in lower costs because complex programming is eliminated and also because of the simplicity of the hardware implementation.

In general terms, the SPO is best described as a digital operational amplifier. While the circuit implementation is digital, the system architecture used to assemble groups of SPOs is similar to one that is normally used with analog operational amplifiers. The analogy is as follows. In comparing the digital SPO to an analog OP-AMP, multipliers correspond to resistors whereas delay (memory) corresponds to inductors and capacitors. An array of analog OP-AMPS, used as integrators, solve differential equations. An array of SPOs is used, in similar fashion, to solve linear difference equations. Both perform digital signal processing operations.

One aspect of the present invention is a digital signal processing object that includes at least one summer element and at least one delay register connected to the at least one summer element. The combination of the at least one summer element and the at least one delay register is arranged and configured to solve a term of a difference equation. The digital signal is processed as an independent variable in the difference equation.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a block diagram of a signal processing object (SPO) in accordance with an embodiment of the present invention;

FIG. 2 is a block diagram of the analog signal interface in accordance with the present invention;

FIG. 3 is a block diagram of an interconnected array of signal processing objects (SPOs) in accordance with the present invention;

FIG. 4 is a block diagram of a single pole digital filter using two SPOs in accordance with the present invention;

FIG. 5 is a detailed depiction of the filter shown in FIG. 4;

FIG. 6 is a is a block diagram of a signal processing object (SPO) in accordance with a second embodiment of the present invention;

FIG. 7 is a chart illustrating SPO timing;

FIG. 8 is a detailed diagram of a line driver in accordance with the present invention;

FIG. 9 is a block diagram of an audio processing system in accordance with the present invention;

FIG. 10 is a block diagram of a hearing aid processing system in accordance with the present invention;

FIG. 11 is a block diagram of an adaptive filter for use in a smart antennae application in accordance with the present invention;

FIG. 12 is a block diagram of a filter for use in a radio system;

FIG. 13 is a flow chart illustrating a method of making an SPO based device;

FIG. 14 is a diagrammatic depiction of a reconfigurable SPO based device; and

FIG. 15 is a block diagram of a reconfigurable system employing the device shown in FIG. 14.

### DETAILED DESCRIPTION

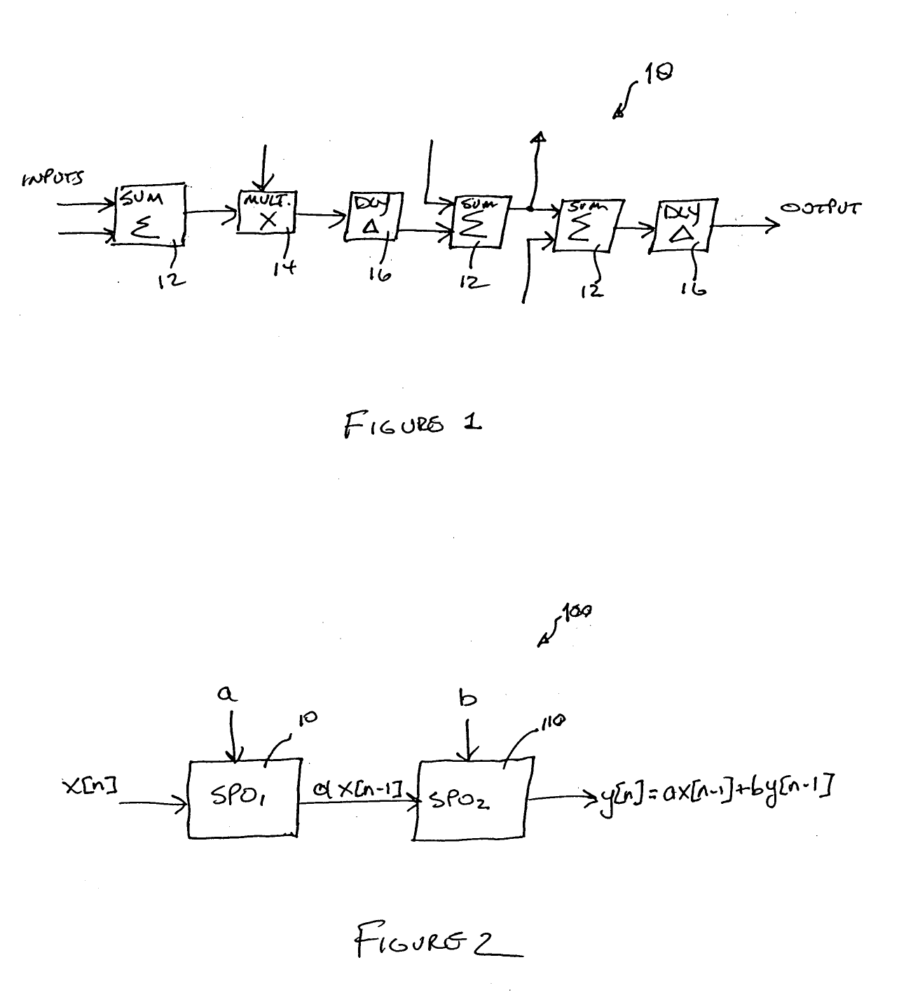

Reference will now be made in detail to the present exemplary embodiments of the invention, examples of which are illustrated in the accompanying drawings. Wherever possible, the same reference numbers will be used throughout the drawings to refer to the same or like parts. An exemplary embodiment of the signal processing object of the present invention is shown in FIG. 1, and is designated generally throughout by reference numeral 10.

As embodied herein and depicted in FIG. 1, a block diagram of a signal processing object (SPO) in accordance with an embodiment of the present invention is disclosed. It will be apparent to those of ordinary skill in the pertinent art that modifications and variations can be made to SPO 10 of the present invention depending on whether the present invention is implemented in software or hardware. For example, if the invention is implemented in hardware, SPO 10 may be implemented in an ASIC, FPGA or custom integrated circuit. SPO 10 of the present invention is best described as a digital operation amplifier. Groups of SPOs may be assembled and interconnected to solve linear difference equations in the performance of digital signal processing operations. Further, the present invention is suitable in any application that employs linear difference equations.

Referring to FIG. 1, the basic SPO 10 is comprised of only two circuit components; an adder 12 and a shift register delay 16. The adder 12 is used to construct the multiplier element 14. For a bit serial implementation, the adder is a simple binary adder with a “D flip-flop type register. The register is used to store the carry signal. For byte-serial, e.g., the adder 12 is comprised of eight binary adders. All are a standard components available in any of the implementation options mentioned above, i.e., FPGA, ASIC or custom integrated chips (ICS). The actual configuration depicted in FIG. 1 is an example configuration. Those of ordinary skill in the art will recognize that the number of adders 12, multipliers 14, and delay elements 16, vary in accordance with the application.

Referring back to multiplier 14, one multiplier algorithm suitable for the present invention employs a 2s complement representation for the binary numbers. The algorithm is based on a standard algorithm as described in Gosling, J. B., Design of Arithmetic Units for Digital Computers, Springer, 1980, pgs. 40-44. However, the present invention should not be construed as being limited by this approach. The multiplier consists of a register to store one of the multiplier inputs and an adder tree to combine the partial products as they are generated. Provision for “sign extension” is made for proper handling of signed numbers.

Another operation, not specifically shown in the simplified diagrams shown above is the rounding operation. This operation is needed when feeding outputs back to the inputs. The word size doubles as a result of the multiply operation so that the word at the output of the multiplier is longer than the input word. The rounder is just an adder with provision for removing the lower order bits at the rounder output. In this way word growth due to feedback is eliminated. Reference is also made to U.S. Pat. No. 3,982,112, which is incorporated herein by reference as though fully set forth in its entirety, for a more detailed explanation of multiplier and a rounder mechanisms.

The number representation can be fixed or floating point and the digital word width can be single or multiple bits. A bit serial, fixed-point implementation is interesting because it closely resembles the analog implementation. In other words, single wires may be used to interconnect multiple SPOs which greatly reduces on-chip and off-chip bussing requirements. Carrying the op-amp analogy forward, just as arrays of analog operational amplifiers can be interconnected to perform analog signal processing operations so arrays of SPOs can be interconnected to perform digital signal processing operations.

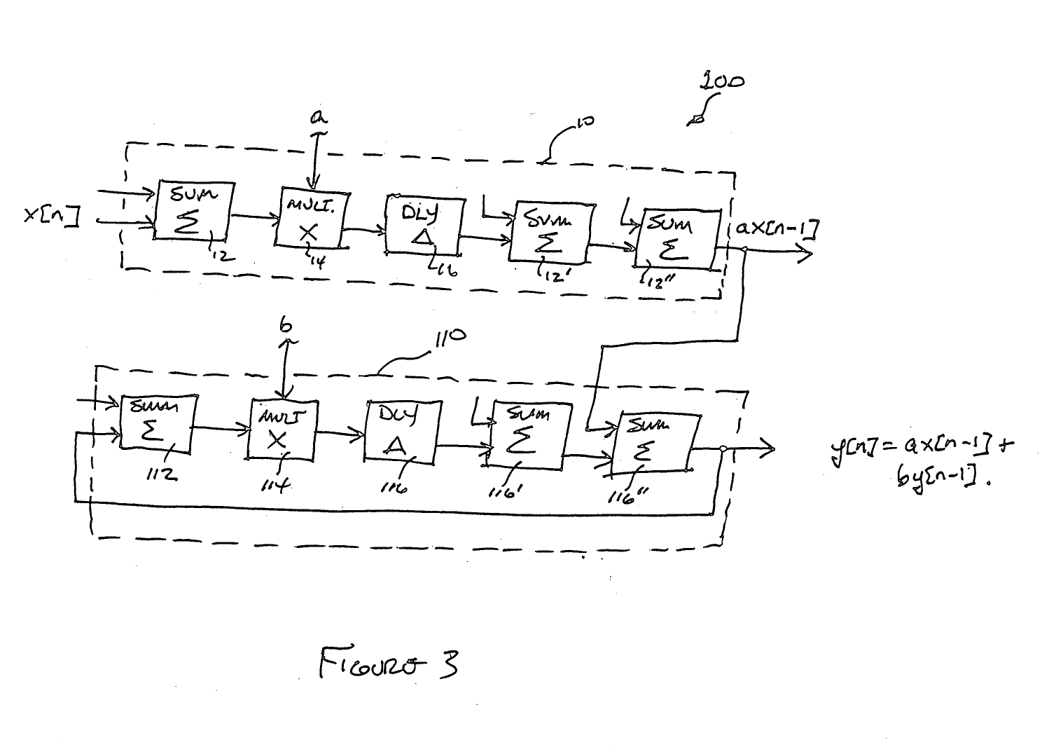

Referring to FIG. 2, a block diagram of a single pole digital filter 100 using two SPOs in accordance with the present invention is shown. In this example, digital signal x[n] is input to SPO 10. SPO 10 delays the digital signal and multiplies it by coefficient “a.” Accordingly, conditioned signal ax[n−1] is provided to a second SPO 110. Ultimately, filter 100 outputs y[n]=ax[n−1]+by[n−1].

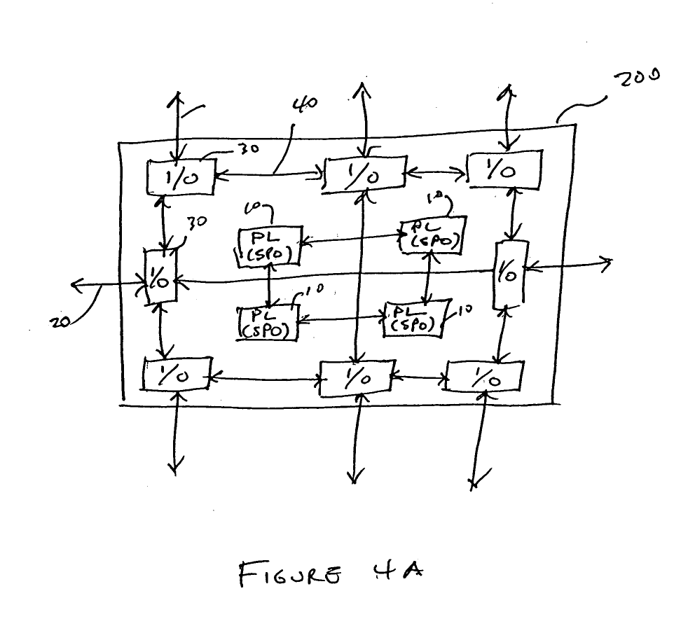

FIG. 3 is a detailed view of the filter 100 shown in FIG. 2. As shown, filter 100 is implemented using only adders 12 (112), multipliers 14 (114), and delay elements 16 (116). In this example, it is presumed that the timing of the signals flowing among the chips is correct. This will be shown to be correct in another example provided below. The present invention employs “built-in” timing that makes SPO programming easy. There is a direct correspondence between the mathematical equations describing the desired filtering operation and the circuit embodiment. Programming amounts to little more than interconnecting the individual SPOs, a task which is easily relegated to a compiler. There is no need to serialize the mathematical equations into complex program loops and/or to manage memory-processor communications.

Accordingly, parallel processing is easily accomplished since it is a direct consequence of the interconnection architecture. One of the many advantages of this digital signal processing architecture is that it eliminates the need for traditional programming required for implementations using conventional DSP circuits. In the following we describe the SPO in terms of bit serial operation, but the same discussion holds for nibble, byte, or word-serial operations.

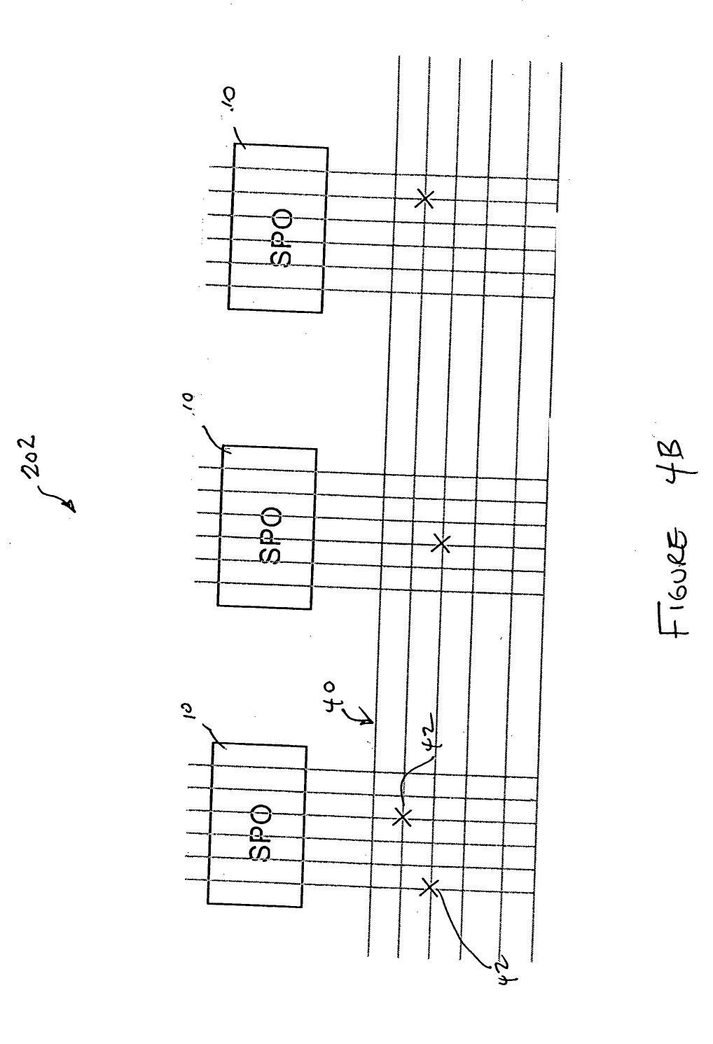

As embodied herein and depicted in FIG. 4A, a block diagram of a typical integrated circuit implementation of the present invention is shown. In the example provided, circuit 200 includes a plurality of input/output (I/O) blocks 30. I/O blocks 30 are connected to external data, signal, addressing, and control lines by way of I/O pins 20. I/O blocks 30 and SPO (programmable logic elements) blocks 10 are interconnected by internal buss system 40.

It will be apparent to those of ordinary skill in the pertinent art that modifications and variations can be made to the circuits 200 of the present invention depending on the tradeoff between system performance and development costs. For example, circuit 200 may be implemented using an FPGA, ASIC or a custom integrated chip (IC).

There are several options for implementing custom VLSI circuits. Typically, SPO components are selected from cell libraries provided by the VLSI technologies currently in production. The task is eased by the availability of software tools from companies such as Synopsis and Cadence. Custom VLSI circuits may offer superior system performance, but they are also the most expensive.

An alternative is the use of ASIC technology, in which case individual circuit components are assembled. Because the SPO architecture is, in itself, modular there is not a great difference between custom and ASIC implementation means. Indeed, one advantage of the SPO architecture is modularity and a single custom circuit can be replicated to produce a large system.

The third alternative is to use FPGAs. Using this approach, individual circuit components are realized as standard component modules offered by the manufacturer. The advantage is a more flexible and cost effective implementation that can be suited to individual needs. It is also feasible to create an SPO standard component module. This would then be used with the other standard component modules to create circuits for a particular application.

Whatever the approach employed, the IC is typically disposed on a circuit board which is inserted into a backplane. Some industry segments are currently converting to the use of bit-serial backplanes in order to reduce wiring costs. These are currently operating at 10 Gigabit, over copper wire. The bit-serial SPO fits very well into this method of data transfer. Once the data is serialized for transfer there will be many opportunities to perform bit-serial signal processing prior to conversion of the data back to parallel format.

Referring to FIG. 4B, a detailed block diagram 202 of an interconnected array of signal processing objects (SPOs) 10 is shown. A problem with SPO arrays, particularly at high frequencies, is that interconnect delay becomes significant. But, it is easy to show how interconnect delay can be incorporated as just another circuit element. The idea is simple. Instead of connecting the SPOs at the bit boundaries defined by the delay within the SPO, merely connect by using a signal which is ‘one bit early’, using the delay in the interconnect path to add the additional bit of delay required for bit alignment at the destination SPO. This is described in more detail in the next section, showing the use of a standard interconnect fabric, available from all vendors.

The idea is to make the interconnect an integral part of the circuit. In effect, the interconnect is just another circuit element. This is a standard architecture which works well in this application since the number of interconnects is relatively small. Each SPO has in the order of 12 pins and they are mostly connected to nearest neighbors over relatively short distances. Even so, it is important to allocate a clock delay to each of these connects. Referring to FIG. 4B, each SPO 10 is connected to the vertical lines with appropriate “vias.” In the case of two metal layers, the horizontal and vertical connection is shown by an “X.” Horizontals are used to connect among SPO circuits.

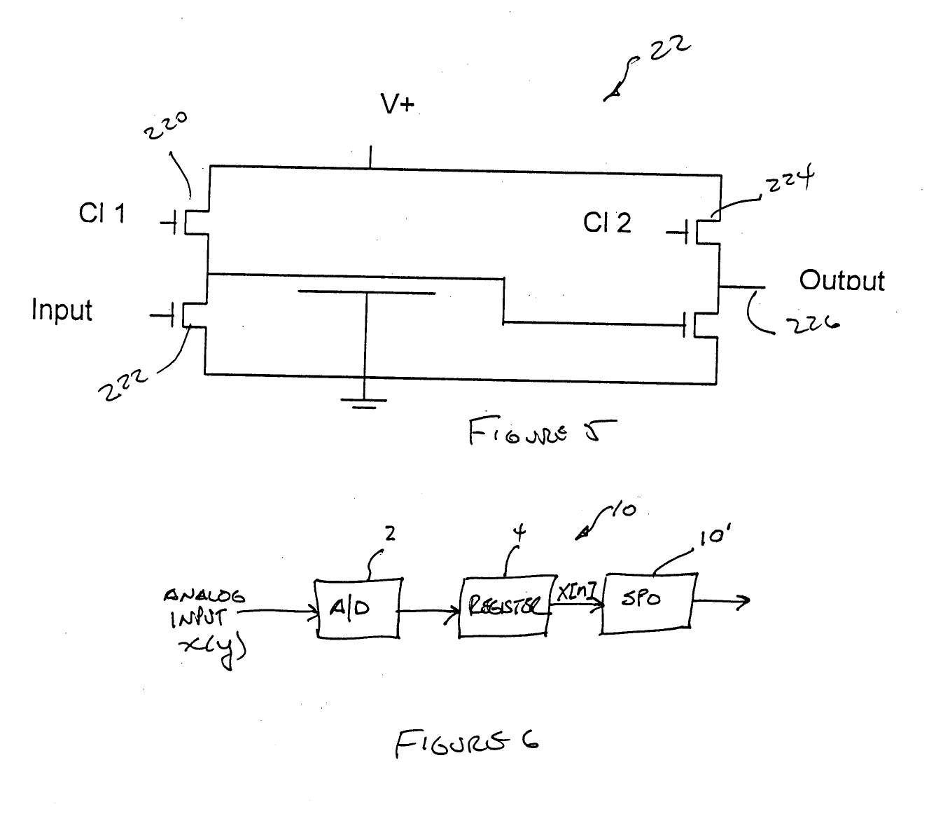

Referring to FIG. 5, a detailed diagram of a line driver that may be employed in FIG. 4A is shown. Signal data is directed into input line 222. Clock 220 charges the line, and clock 224 transfers the data to output 226. This operation consumes one clock cycle. This is easily incorporated into SPO timing. In particular, this operation represents a one bit delay.

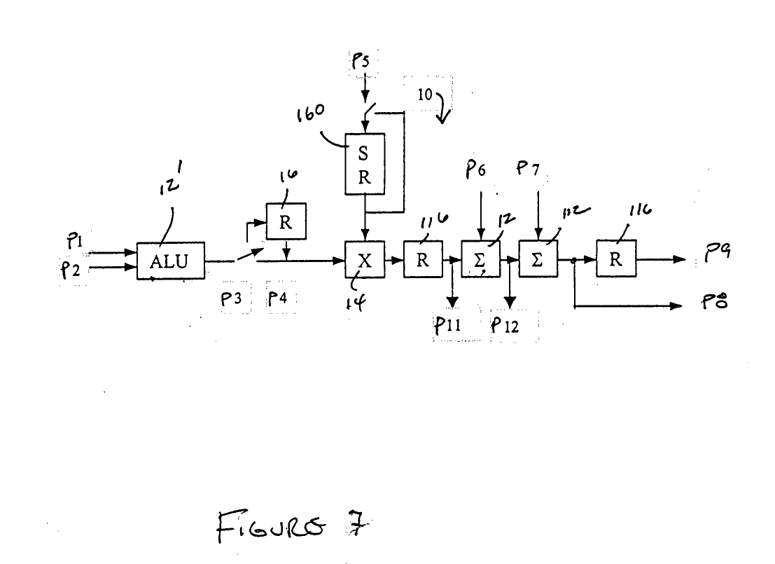

Referring to FIG. 6, a block diagram of an analog signal interface in accordance with the present invention is shown. Referring to FIG. 4A, the programmable logic block 10 may accommodate analog signals x(y). Thus, block 10 includes an A/D converter 2 that is coupled to a register 4. The output of register 4 is digital signal x[n], which is directed into SPO 10′. Those skilled in the art will recognize that a conventional pipeline A/D converter is a natural analog input interface to the SPO. The A/D may be implemented using single or multiple stages. There is a slight complication since the A/D produces bits most-significant-bit (msb) first while the SPO uses the least-significant-bit (lsb) first. This is easily solved by using a pair of buffer registers, represented by register 4 in FIG. 6.

For example, during a 64-bit SPO word time, a single stage pipeline A/D stores one digitally corrected 16-bit sample in shift register ‘A’. While register ‘A’ is clocked (lsb first) into the SPO at 2.56 GHz, the next sample is being generated and stored in register ‘B’. This cycle continues, alternating between registers A and B. The A/D clock rate may be 160 MHz, with a 40 MHz analog sample rate.

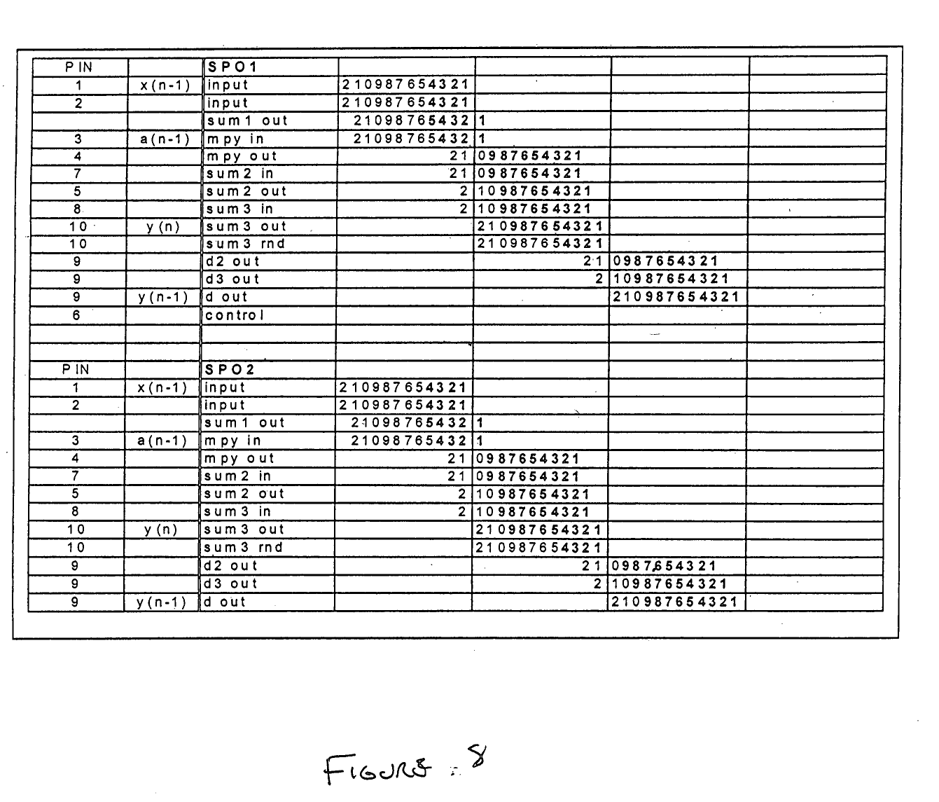

As embodied herein and depicted in FIG. 7, a block diagram of a signal processing object (SPO) in accordance with another embodiment of the present invention is shown for the purpose of illustrating SPO timing. FIGS. 7 shows pin-outs, whereas FIG. 8 shows the progression of signals through the SPO. This example employs a 4 bit input word length with a 12 bit internal data word. Typically, for increased dynamic range, the internal data word is chosen to be greater than the sum of the individual multiplier inputs, which is the minimum required.

In FIG. 7, the usual input summer 12 is replaced by an arithmetic logic unit (ALU) 12′. Those of ordinary skill in the art will recognize that an ALU provides additional flexibility over a simple summer. One advantage of the ALU, over the summer/multiplier, is that it permits a “greater-than” operation at the input. This operation is useful in applications such as the approximate calculation of magnitude and implementation of the Cordic algorithm.

The following description assumes bit-serial operation. An analogous description holds for nibble-, byte-, word-serial operation. FIG. 4 shows a more detailed diagram.

Data enters the SPO 10, lsb (least significant bit) first, and all operations are performed in pipeline fashion. Data is organized into “word” lengths by means of a word clock. As mentioned, timing is critical for proper operation. In this regard it is important to understand that the output of the SPO is delayed by exactly one word, so that it can be fed into the input or into another SPO as required by the mathematical difference equations. In these equations the notation y(n−1), e.g., is the variable y(n) with one word delay. Thus if y(n) is input to a delay register, the output is y(n−1), as required. The SPO itself, in addition to the math operations, also produces a one-word delay.

Digital signal processing has stringent requirements for the numerical properties of the operations. Typically, multiplier coefficients must be represented as 16 bits or larger, and internal (to the SPO) word size can range to 64 bits or larger.

Rounding is needed when feeding outputs back to inputs to limit word growth, but unfortunately this introduces an error and it should be avoided, if possible. The error is small, but becomes significant in the execution of high order filtering operations. The SPO has provision for mitigating this error by providing a means for feedback that does not pass through the multiplier and thus suffers no rounding error. In FIG. 7, Pin 9 to Pin 6 is such a path and permits multiple iterations to occur with no error, as long as the word length is not exceeded. Without this provision the SPO architecture would not be viable.

Referring to FIG. 8, a chart illustrating SPO timing is shown. In this chart the output on pin 10, compared with pin 1, is delayed by exactly one word. Pin 9 is delayed by two words, compared with pin 1, since the data has passed through a register. Word boundaries are denoted by the heavy vertical lines.

One of the most important features of the SPO architecture is the interconnect means previously discussed. The timing of each of the circuits is designed to provide paths among the circuits which are in proper bit alignment and which provide for the word delays demanded by the signal processing algorithms. Remembering that we are concentrating on bit-serial operation the spreadsheet in FIG. 5 shows the relationship among the bit times and word times.

In this example the numerals indicate bit positions and we assume that the input data word is 4 bits and the remaining 8 bit times are used to accommodate word growth. The input, x(n−1), is located at the boundary of the word clock, indicated by the vertical lines in the spreadsheet. I.e., bits ‘4321” constitute the input data. After the multiplier, bits ‘87654321’ constitute the data. The remaining bit positions are reserved for word growth, as might occur with multiple additions as data is passing through the device.

Keeping track of the relationship between bit times and word times is confusing; but with a little practice the relationship between bit flow and word flow becomes apparent. In FIG. 8, think of the bits as marching to the right as they are moving through the SPO. When a word emerges from the SPO, it is necessary that it be in bit alignment with the input word. Of course, it is delayed by one word time. However this is exactly what is demanded by the signal processing equations. The ‘word’ meaning of the signals is denoted in column 2.

It is necessary to be able to interconnect the SPOs at points other than at the word boundaries at the input and output as shown in FIGS. 1 and 2. These intermediate connections are required to permit more than one interconnect between SPO circuits, as is generally required by the signal processing equations. An SPO output which is one bit time early can be connected to another SPO which is also one bit time early. In this way the SPOs form a tessellating pattern which can, in principle, continue ad infinitum, were it not for the fact that the interconnect will produce a delay. As circuit speed increases, such delay will become of the same order as the clock period. The SPO architecture provides a unique solution to this problem that will be described below. However, first lets us trace through the spreadsheet in more detail.

Note that the output of the first summer is delayed by one bit, because the summing function takes one clock period. This is denoted by sliding the input word by one bit to the right; i.e., sliding bit 1 into the next word period.

The multiplier is allocated 10 clock periods, and these in combination with the delay produced by the other summers slides the bits to the right, such that the output on pin 10 is located entirely within the next word. These numbers represent the bit alignments among the pins of the SPO. When SPOs are interconnected, the signals must be in proper bit alignment.

Column 2 shows the word alignment of the signals at each of the pins. Thus, e.g., if pin 10 is labeled y(n) then the “word” meaning of pin 9 is y(n−1). I.e., it is the previous word that is emanating from pin 9 (P9).

This bit timing is the mechanism that allows a large number of SPOs to be connected in arrays to perform signal-processing operations. There are, in effect, many points at which the SPOs can be connected, while still maintaining the proper ‘word’ relationships among the data, as dictated by the signal processing equations. The examples shown above indicate how this is done. Other examples are presented below.

In this way timing is part of the architecture and as noted in the introduction, there is no programming in the traditional sense. Parallel execution obtains easily and naturally by interconnecting circuits in proper bit alignment.

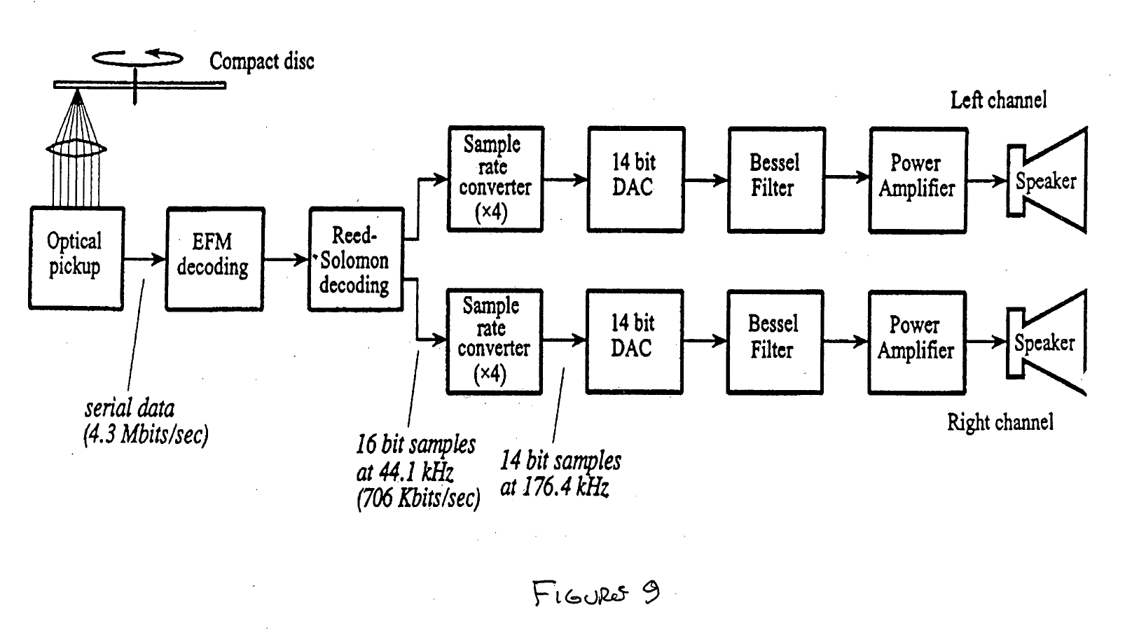

Applications for the SPO are wide-ranging. Some examples are described in FIGS. 9-12. It is important to note that DSP is inherently a parallel operation. For example, the linear difference equation representing a two pole digital filter is:
y(n)=a*x(n−2)+(1−b)*y(n−1)+(1−c)*y(n−2).
Accordingly, the SPO architecture provides an SPO configured to execute each operation (equation term) on the right hand side of this equation simultaneously. A conventional DSP does one (or a few) at a time. Thus, the parallel processing capabilities of the present invention are well suited for embedded DSP applications.

Referring to FIG. 9, a block diagram of an audio processing system in accordance with the present invention is disclosed. One application for the SPO would be in conventional audio processing. Below is a typical block diagram for a CD playback system. Note the serial data stream at the output of the optical pickup. This could be fed directly to the SPOs for processing. Special circuits usually perform the decoding operations, but they could be performed by the SPO. However the sample rate converter is perfect for SPO implementation.

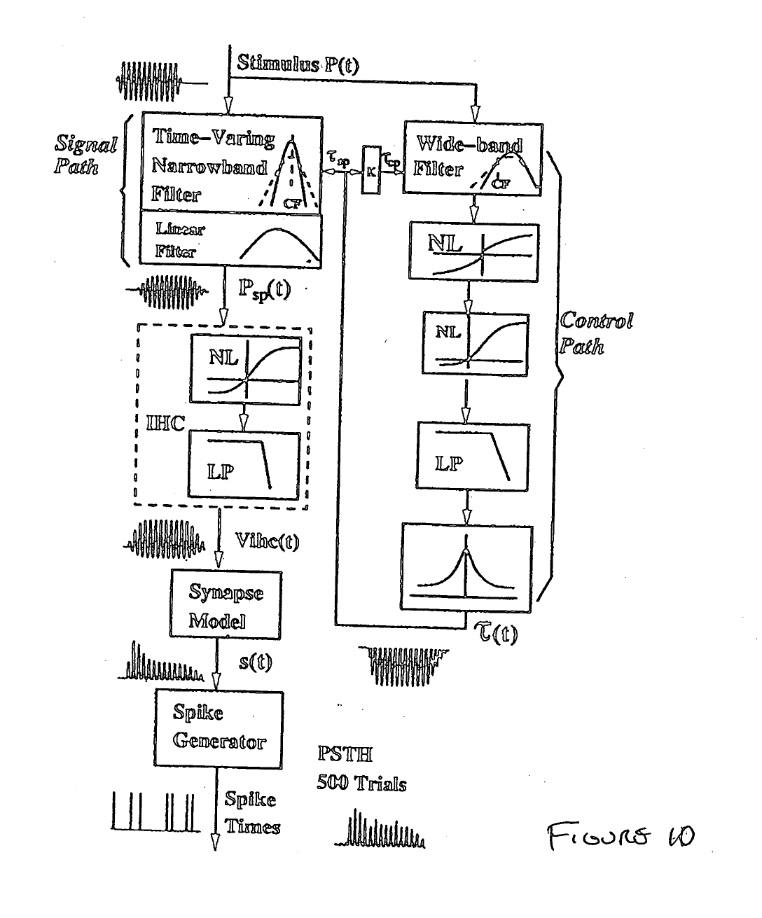

Referring to FIG. 10, a block diagram of a hearing aid processing system in accordance with the present invention is disclosed. An excellent application for the SPO architecture is the implementation of circuits needed to model the hearing process in the ear. Professor L Carney at ISR, Syracuse University, has developed the following block diagram and requirements.

The SPO is ideally suited to implementing these models, including both linear and nonlinear effects. It is able to do this with size and power suitable for a device that could be fit into a typical hearing aid.

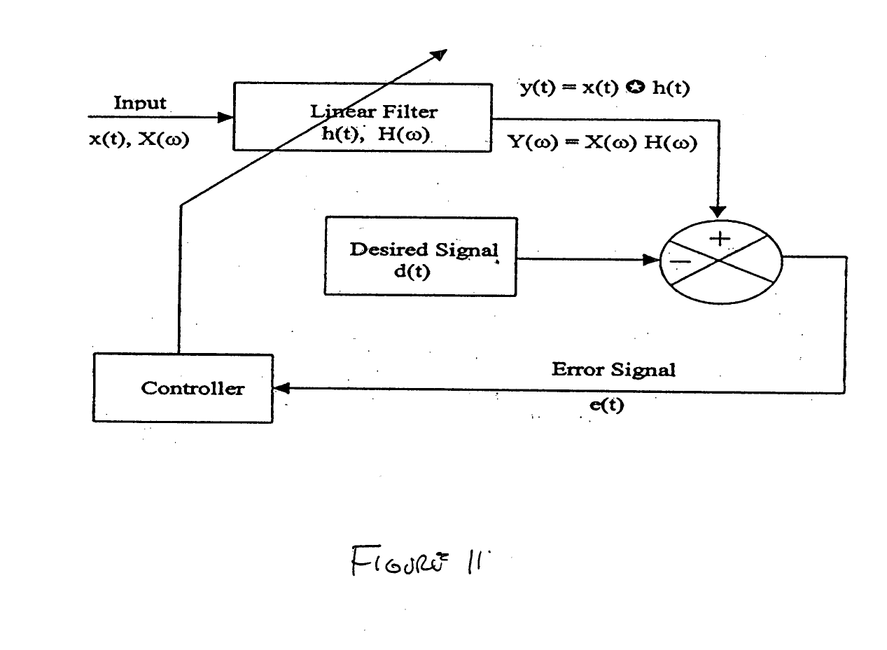

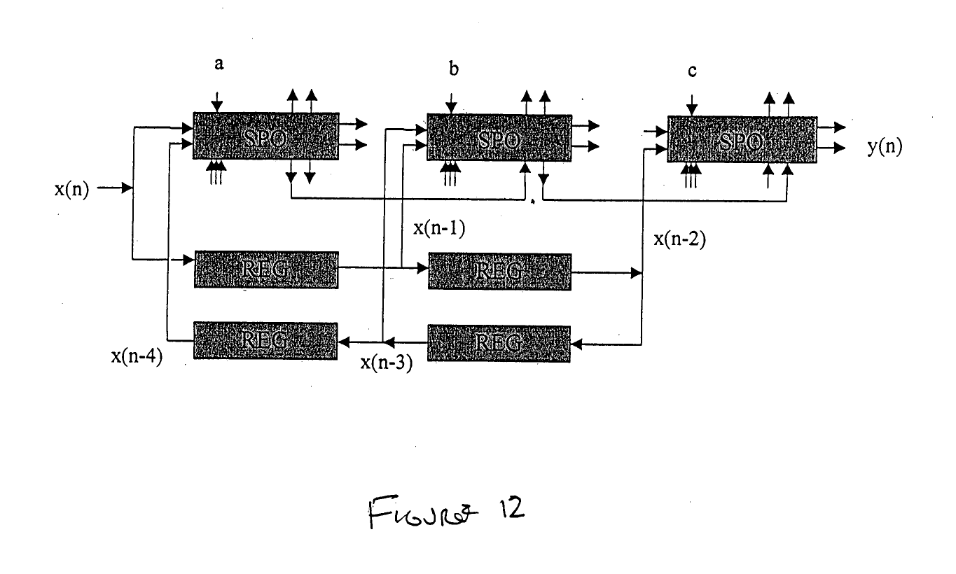

Referring to FIG. 11, a block diagram of an adaptive filter for use in a smart antennae application in accordance with the present invention is disclosed. Of the many radar applications, one that requires enormous processing power is the implementation of smart antennas. Typical tasks are corrections for non-planarity of the arrays, beam forming and direction finding. Prof. T. Sarkar has developed the equations and algorithms needed to perform these operations. In discussions with Dr Sarkar, it is clear that the SPO is ideally suited to providing the computing power needed. A typical circuit is the adaptive filter shown below. The linear filter in this figure is precisely the same structure as the FIR filters mention above and is well suited to SPO implementation. Referring to FIG. 12, a block diagram of a filter for use in a radio system is disclosed. An important application for Fir filters is sample rate change; decimation and interpolation. These are some of the most compute intensive operations in such applications. As an example, decimation is accomplished with a series of filters that halve the sample rate. To meet the aliasing requirements, a sharp low pass filter is needed. Interpolation is similar.

Each stage requires a sharp cutoff low pass filter, usually implemented with a FIR filter with, in the order of, 20 terms. However there are only 10 multiplier constants so that such a filter is realizable with just 10 SPOs. Further, since the sample rate is reduced at each stage, by introducing the input into every other word slot, one 10-stage SPO configuration is able to perform an arbitrary number of x2 decimations. FIG. 12 shows an implementation for a 5-stage filter in which there are three unique coefficients, a, b, c.

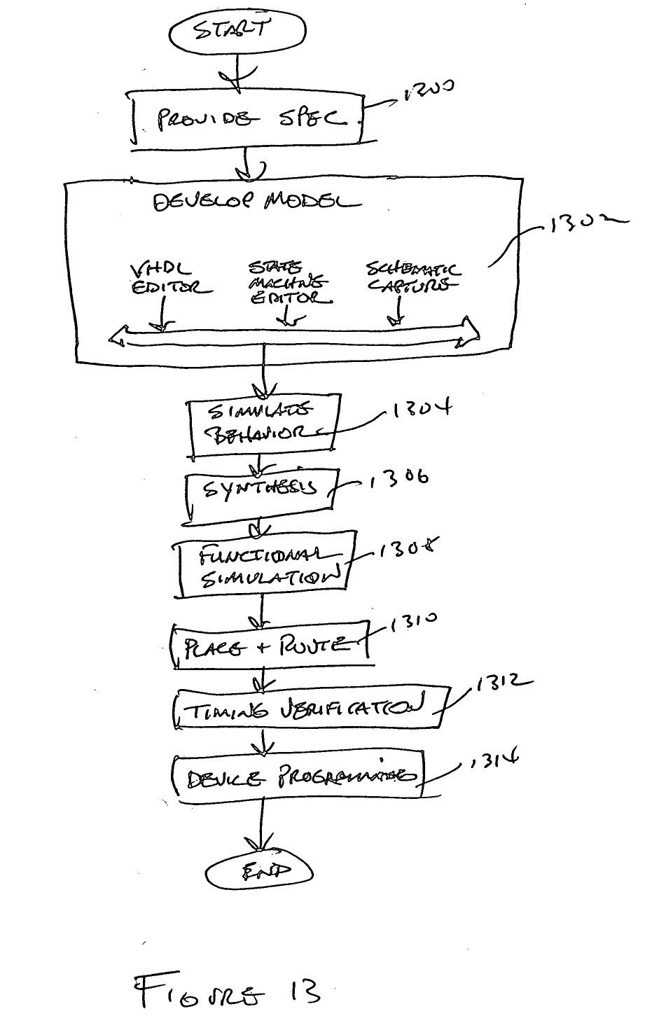

FIG. 13 is a flow chart illustrating a method of making an SPO based device. Obviously, the first step in the process is determining the DSP operation to be effected. Thus, the specification of the SPO based design is driven by the application. For example, FIG. 2 and FIG. 3 show a single-pole filter. FIGS. 9-12 also show various types of applications. FIG. 12, for example, shows a ten-stage SPO configuration. As noted above, each SPO represents a term in a difference equation. The design specification is an unambiguous definition of the components and interfaces

In step 1302, the specification is used to create a model of the design. The model may be captured using a VHDL editor, a state machine editor or a schematic capture tool. The term “behavior” simulation relates to the SPO based algorithms, Boolean expressions, transfer functions, and/or register transfers being simulated. During synthesis, the SPO design is translated into a structural description. SPO combinatorial logic infers that certain gates will be arranged in sequence to provide adders and multipliers. The structural description of an SPO also infers the use of registers to provide delays. In step 1308, a functional simulation of the SPO design is performed. The functional simulation attempts to predict the propagation of signals through the various programmable logic blocks. The functional simulation helps the designer to understand the sequence of events. As noted above, each logic block may represent a term in a difference equation. In some cases it may be possible to include more than one terms in a logic block.

In step 1310, each of the programmable blocks are mapped to a portion of the target device. The interconnection of these blocks determines the routing of signals within the device. In step 1312, chip timing is analyzed based on the placement and routing performed in step 1310. Once the design has been verified, the target device is programmed accordingly.

Those of ordinary skill in the art will recognize that companies such as Xilinx, Alterra, Cadence, and Synopsis supply software tools required to implement the steps described above.

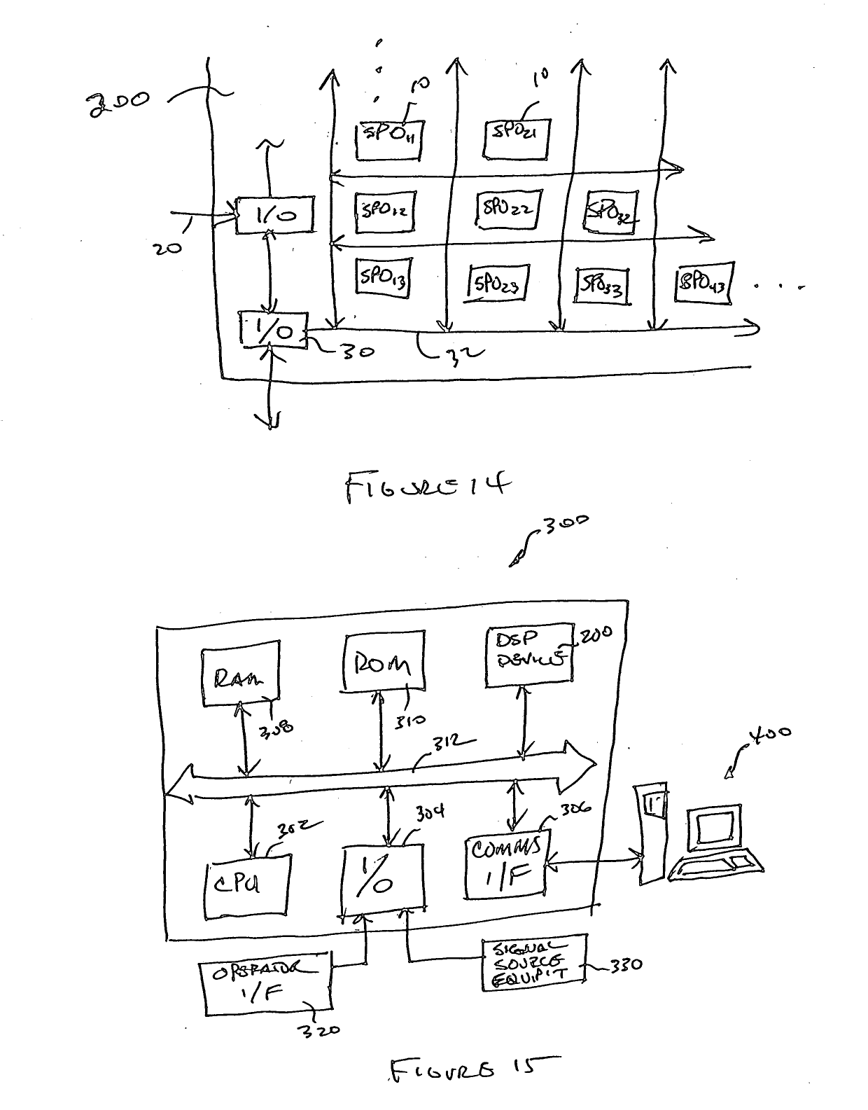

FIG. 14 is a diagrammatic depiction of a reconfigurable SPO based device. In this embodiment, device 200 includes a library of SPO logic blocks. One or more programmable logic blocks 10 are programmed with a specific SPO design based on the application. The interconnections 32 between the various logic blocks 10 may be changed depending on the changing processing environment.

FIG. 15 is a block diagram of a reconfigurable system 300 that includes the device 200 shown in FIG. 14. System 300 may be an embedded design coupled to signal source equipment 330. Signal source equipment 330 may represent a sonar system, a radar system, the front end of a radio, or one of the systems described in FIGS. 9-12. Those of ordinary skill in the art will recognize that the list of applications is not exhaustive, and the present invention should not be construed as being limited to this list of applications.

Referring to FIG. 15, system 300 includes CPU 302, I/O circuit 304, communication interface 306, RAM 308, ROM 310, and DSP device 200 interconnected by buss 312. for storing information and instructions to be executed by the processor 803. RAM 308 is typically used for storing temporary variables or other intermediate information during execution of instructions by CPU 302. System 300 may further include a read only memory (ROM) 310 for storing static information and instructions for execution by processor 302. One of the functions of the I/O circuit 304 is to route analog signals to DSP device 200 by way of buss 312. The communications interface 306 provides two way communications to host device 400. Host computer 400 may be coupled to system 300. In this embodiment, host 400 provides CPU 302 with the necessary instructions for reconfiguring DSP device 200. In another embodiment, CPU 302 may be programmed to change device 200 interconnections on the fly, so to speak. As described above, device 200 includes a library of SPOs, each of which represents a term in a difference equation. Of course, the various combinations of terms are predetermined in the design stages to ensure that the timing between blocks is functional.

The present invention includes many features and benefits. Inclusion of timing as an integral part of this architecture. As noted above, the programming is performed by interconnecting the SPO circuits as prescribed by the mathematical equations. This eliminates any intermediary programming steps of converting the mathematical prescription to a set of sequential steps to be executed on a conventional DSP.

Local memory is provided for each processor, eliminating memory fetches that are required when a few multipliers are shared among many operations. The present invention may provide hundreds of SPOs in a single chip, the SPOs operating in parallel without concern for deadlocks and/or race conditions. The present invention eliminates complicated parallel programming constructs, such as flags and semaphores, which are ordinarily required to keep the parallel operations flowing smoothly. With this architecture there is no programming in the traditional sense. There is a one-to-one correspondence between the math and the hardware.

Further, the present invention provides an architecture that enables area- and power-efficient bit serial circuits to take advantage of modern high speed, low density circuit technology. Speed is obtained through parallelism. The inevitable delays caused by interconnections are incorporated into the design. This is an important feature because the speed of signal transmission becomes comparable to speed of circuit operation.

The present invention may implement any signal processing operation at any level of accuracy and precision. Further, the present invention provides a simple and convenient means for reprogramming the SPO array (i.e., device 200). In a multilayer VLSI embodiment, the array of SPOs are disposed on one layer whereas the interconnection fabric is disposed on another layer. Programming is achieved by creating programmable vias that effect the desired connections. Interconnect fabric technology is highly developed and can meet the requirements imposed by the SPO architecture.

The op-amp analogy is important because, going forward, as the concept of the SPO becomes better understood, the SPO-based op-amp could become as ubiquitous as the analog op-amp.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A digital signal processing circuit comprising:
at least one summer element; and
at least one delay register coupled to the at least one summer element, the combination of the at least one summer element and the at least one delay register being arranged and configured to solve a term of a difference equation, the digital signal being processed as an independent variable in the difference equation.

2. The circuit of claim 1, further comprising at least one multiplier element coupled to the at least one summer element and/or the at least one delay element.

3. A digital signal processor for processing a digital signal, the processor comprising:
a first digital signal processing object including at least one first summer element coupled to at least one first delay register, the combination of the at least one first summer element and the at least one first delay register being arranged and configured to solve a first term of at least one difference equation; and
at least one second digital signal processing object synchronously connected to the first digital signal processing object, the at least one second digital signal processing object including at least one second summer element and at least one second delay register connected to the at least one second summer element, the combination of the at least one second summer element and the at least one second delay register being arranged and configured to solve at least one second term of a difference equation, the first digital signal processing object and the at least one second digital signal processing object being configured to solve the difference equation, the digital signal being processed as an independent variable in the at least one difference equation.

4. The processor of claim 3, further comprising a programmable interconnection array configured to synchronously connect the first digital signal processing object with the at least one second digital signal processing object.

5. The processor of claim 4, wherein the programmable interconnection array is programmably configured to execute the first term and the at least one second term of the difference equation substantially simultaneously.

6. The processor of claim 4, further comprising a means for reprogramming the processor coupled to the first digital signal processing object and the at least one second digital signal processing object.

7. The processor of claim 6, wherein the means for reprogramming is configured to convert the at least one difference equation into an interconnection mapping of the first digital signal processing object and the at least one second digital signal processing object, the interconnection mapping corresponding to at least one difference equation.

8. A system comprising:
a signal source configured to provide a digital signal; and
a digital signal processor coupled to the signal source, the digital signal processor including a plurality of digital signal processing objects synchronously interconnected by a programmable interconnection array to solve at least one first difference equation, each of the plurality of synchronously interconnected digital signal processing objects being configured to solve a single difference equation term of the at least one difference equation, the digital signal being an independent variable in the at least one first difference equation.

9. The system of claim 8, wherein the digital signal processor solves the at least one first difference equation by performing fixed or floating point calculations.

10. The system of claim 8, wherein the digital signal processor is implemented as an FPGA device, an ASIC, or as a custom integrated circuit.

11. The system of claim 8, wherein the digital signal processor is configured to solve a plurality of first difference equations.

12. The system of claim 8, wherein the plurality of digital signal processing objects are interconnected by the programmable interconnection array in parallel to thereby execute each of the difference equation terms substantially simultaneously.

13. The system of claim 8, further comprising a means for reprogramming the digital signal processor, whereby the programmable interconnection array is reprogrammed to interconnect the plurality of digital signal processing objects to implement at least one second difference equation.

14. The system of claim 13, wherein the at least one second difference equation includes a plurality of second difference equations.

15. The system of claim 8, wherein each of the plurality of digital signal processing objects comprises:
at least one summer element;
a multiplier element coupled to the at least one summer element; and
at least one delay register coupled to the at least one summer element and/or the multiplier element, the combination of the at least one summer element, the at least one delay register, and/or the multiplier element being arranged and configured to solve a term of a difference equation, the digital signal being processed as an independent variable in the difference equation.

16. The system of claim 8, wherein the signal processor is configured as a digital filter.

17. The system of claim 16, wherein the digital filter is an adaptive filter.

18. The system of claim 8, wherein the digital signal processor is configured as an audio and/or video processing system.

19. The system of claim 8, wherein the signal source and the digital signal processor are disposed in a transmitter portion of a communications system.

20. The system of claim 8, wherein the signal source and the digital signal processor are disposed in a receiver portion of a communications system.
